(19) United States
(12) Patent Application Publication
(10) Pub. No.: US 2005/0128748 A1
(43) Pub. Date: Jun. 16, 2005

(54) Signaling system and warning apparatus

(75) Inventor: Yoshikazu Suwa, Kitamoto-shi (JP)

Correspondence Address: KOLISCH HARTWELL, P.C., 520 S.W. YAMHILL STREET, SUITE 200, PORTLAND, OR, 97204, US

(73) Assignee: Kobishi Electric Co., Ltd.

(21) Appl. No.: 10/971,459

(22) Filed: Oct. 21, 2004

(30) Foreign Application Priority Data
Dec. 12, 2003 (JP) PAT. 2003-414908

(51) Int. Cl. F21V 33/00

(52) U.S. Cl. 362/253

(57) ABSTRACT

A light warning apparatus includes a strobe light source, a reflecting mirror that reflects light from the strobe light source, and lens that covers the strobe light source and the reflecting mirror, and a tinted coating layer is formed on the surface of the reflecting mirror. In addition, a colored light signaling device includes a tinted lens cover and a colored reflecting mirror coupled to the lens cover. A strobe light emitting device adapted to provide a sequence of flashing light is disposed in relation to the reflecting mirror so that the light is distributed in a predetermined pattern. The colored reflecting mirror provides a polar light distribution of the flashing light.

### BACKGROUND OF THE INVENTION

1. Field of the Invention

The present invention is related to a light warning apparatus that is disposed inside or outside a building, and can warn people who are in the building or people who are in the vicinity of the building by using light our sound during an emergency such as a fire. Furthermore, the present invention relates to emergency signaling systems, and more particularly, to a colored light signaling system that generates colored light signals that correspond to a selected emergency situations as defined by industrial applications and/or government regulations.

2. Description of Related Art

Conventionally, apparatuses that generate a warning using light during a fire, for example, have been proposed. However, the light source used in these warning apparatuses is a normal light bulb, and the effectiveness of the warning using the light is not very effective. Making a light source stronger in order to solve this drawback can be considered.

In addition, a multi-function warning device that uses the flashing of a strobe light source (a discharge tube using a xenon gas) is disclosed in Japanese Unexamined Patent Application, First Publication No. Hei 7-51113. Here, a warning device for preventing purse-snatching of a purse being held by using a buzzer or light that automatically turns on and off is disclosed.

However, by simply strengthening the light source of a conventional light warning apparatus, depending on the conditions, the effectiveness of the warning may be small. In addition, in the case of the above citation using a strobe light source, because the strobe light source is a white flashing light, there is the problem that depending on the conditions of use it may be difficult to recognize. In addition, it is difficult to impart a color to the strobe light source.

Building emergency warning systems are required by law and are now commonplace in most commercial structures. These warning systems generally include an audible signaling device, such as a horn, siren or bell, that provides an audible signal at a decibel level sufficiently high to be heard by persons within a limited vicinity of the warning system. Industry standards have evolved to require visual signals, i.e. flashing lights, for emergency warning systems. In 1990, the Americans with Disabilities Act (ADA) recognized the importance of visual signaling devices. The ADA specifically included provisions and standards for visual and audible signaling devices designed for the protection of the hearing impaired. Similarly, industry-based regulatory bodies, such as the National Fire Protection Association (NFPA), Underwriter's Laboratories (UL), the American National Standards Institute (ANSI), and the National Electrical Manufacturers Association (NEMA), have guidelines that require visual signaling devices.

In addition to adding visual signals to building emergency warning systems, government regulations have mandated that employers subject to OSHA regulations implement a warning system that “use[s] a distinctive signal for each purpose.” OSHA Reg. 1910.38(d). A system that employs colored emergency signal devices may serve that purpose.

Colored visual signaling systems are known in the prior art. Such systems generally comprise a silver reflecting mirror positioned behind a lightbulb covered by a color tinted lens cover. The lightbulb may, for example, be energized by a strobe light system. There are limitations, however, associated with these types of systems. If the tinted lens cover is to light in color, the signal light looks like white light to the observer, and it is therefore ineffective in communicating a color coded signal. Thus, in order to effectively flash a colored light, the tinted lens cover must be tinted very dark in color. Due to the darkness in color of the lens cover, however, the light output of the colored lighting device is diminished in intensity when compared to a non-colored signal.

Under the ADA guidelines, non-colored visual signaling devices must provide a minimum light intensity of 75 candela (cd) in all areas and the devices must be spaced so that no place in any room is more than 50 feet from the nearest device. The industry-based standards recognize that an equivalent illuminance to 75 cd can be achieved using lower intensity strobes (e.g., 15 or 30 cd) spaced closer together (e.g., within 20 feet). The industry-based standards and the ADA guidelines also set forth different intensity requirements for sleeping and non-sleeping areas. Sleeping areas are given a much higher intensity requirement than non-sleeping areas so that the visual signaling devices will wake hearing-impaired persons from their sleep. The darkness of the tinted lens cover, therefore, presents difficulties in achieving the intensity or brightness required by the industry and ADA standards for visual emergency systems.

Alternatively, due to the increased intensity requirements of industry standards and ADA regulations, dark lens covers require an increased energy output for the lightbulb to obtain compliance. In contrast, a visual non-colored emergency system which only utilizes white light uses less energy. Thus, in order for a colored light emergency system to achieve the same intensity as a non-colored light system, the energy input must be increased with a corresponding increase in heat generated by the signaling device and potentially shortened life cycle. Energy conservation measures also make a visual emergency system which utilizes less energy desirable.

In order to resolve the deficiencies of present visual color-coded signaling systems, the applicant proposes an apparatus that will better comply with industry and ADA intensity standards while achieving conservation in energy output. It should be noted that the technique utilized by the present invention to make the apparatus more efficient for its purpose has broader application to other colored light signaling devices. For example, other colored light signaling systems such as brake lights, warning lights or traffic light signals, can receive the same benefits of increased light output while decreasing energy output by utilizing the applicant's invention.

### SUMMARY OF THE INVENTION

A light warning apparatus according to the present invention comprises a strobe light source, a reflecting mirror that reflects light from the strobe light source, and a lens that covers the strobe light source and the reflecting mirror, wherein a tinted coating layer is formed on the reflecting mirror surface.

In addition, in the present invention, the lens and the tinted coating layer may be tinted the same color.

In addition, in the present invention, the reflecting mirror is formed by reflecting surfaces that have a plurality of slopes.

In addition, in the present invention, the reflecting mirror has a concave surface consisting of a plurality of conical surfaces having different apex angles.

In addition, in the present invention, a warning sound generating mechanism is provided in proximity to the lens.

The light warning apparatus of the present invention explained above comprises a strobe light source, a reflecting mirror that reflects light form the strobe light source, and a lens that covers the strobe light source and the reflecting mirror, and a tinted coating layer is formed on the reflecting mirror surface, and thereby the light from the strobe light source having a white color can be colored and the effectiveness of the warning can be increased. In addition, due to coating the reflecting surfaces, the reflecting surfaces can be protected and the deterioration of the reflecting effect due to environmental conditions can be prevented.

In addition, in the light warning apparatus of the present invention, the lens and the tinted coating layer may be tinted the same color, and thereby the white light from the strobe light source can be more effectively colored. In addition, it is possible to select effective coloring depending on the conditions of use of the light warning apparatus.

In addition, in the light warning apparatus of the present invention, the reflecting mirror is formed by reflecting surfaces that have a plurality of slopes, and thereby the light from the light source can be effectively scattered, and the effectiveness of the warning can be increased.

In addition, in the light warning apparatus of the present invention, a warning sound generating mechanism is provided in proximity to the lens, and thereby it is possible to generate a warning by using sound in addition to light, and the effectiveness of the warning can be increased.

The reflecting mirror is color coated and the lens is also tinted the same color, and thereby, a light warning apparatus is realized that uses a tinted strobe light, and thereby increases the effectiveness of the warning to the vicinity.

A visual color-coded emergency signaling device comprises a light emitting device adapted to provide a constant or sequenced flashing light is disposed in front of a colored reflecting mirror under a tinted lens cover. The color of the reflecting mirror is matched to the color of the corresponding tinted lens cover. The color of the reflecting mirror and lens cover can be selected according to the specific emergency situation or intended colorized display.

The colored reflecting mirror comprises a reflecting mirror coated with a colored reflective coating. With the use of the colored reflecting mirror, the tinted lens cover does not need to be tinted to a dark color to obtain a colorized light output, and the candela output of the signaling device is not damped by a dark lens cover.

The colored reflecting mirror may comprise four corner reflectors separated by channel segments disposed in first and second axial directions. Respective ones of the channel segments disposed in the first axial direction are further disposed at an angle with respect to each other, and respective ones of the channel segments disposed in the second axial direction are further disposed at an angle with respect to each other. The particular arrangement of the channel segments and corner reflectors produces a polar light distribution pattern.

In an embodiment of the invention, the visual color-coded emergency signaling device further comprises an oscillator for providing an oscillating signal to drive the light emitting device. The oscillating signal is converted to a desired voltage level provided to the light emitting device. The voltage level applied to the light-emitting device is changed, and thereby the intensity level of the light emitting device is changed, by varying the frequency of the oscillating signal. The oscillator is provided by an operational amplifier having a feedback resistance defined between an inverting input terminal and an output terminal, and a capacitance defined between the inverting input terminal and a voltage reference. The frequency of the oscillating signal is changed by a switch adapted to couple an additional resistance in parallel with the feedback resistance. The oscillating signal is converted to a voltage level by an inductor and a capacitor coupled in parallel with the light emitting device. The inductor stores current during a first portion of a cycle of the oscillating signal and the capacitor is charged to the voltage level during a second portion of a cycle of the oscillating signal.

A more complete understanding of the visual color-coded signaling system will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a planar drawing showing an embodiment of the light warning apparatus of the present invention.

FIG. 2 is an enlarged longitudinal drawing showing the same light warning apparatus.

FIG. 3 is a frontal drawing showing the lens used in the same light warning apparatus.

FIG. 4 is a planar drawing showing the same lens.

FIG. 5 is a planar drawing showing the reflecting mirror used in the same light warning apparatus.

FIG. 6 is a frontal drawing showing the reflecting mirror used in the same light warning apparatus.

FIG. 7 is a cross-sectional drawing of the reflecting mirror shown in FIG. 5 along the line A-B.

FIG. 8 is a cross-sectional drawing of the reflecting mirror shown in FIG. 5 along the line C-D.

FIG. 9 is a drawing for explaining the reflecting surfaces that form the same reflecting mirror.

FIG. 10 is a drawing for explaining the reflecting surfaces that form the same reflecting mirror.

FIG. 11 is a planar drawing showing another embodiment of the same light warning apparatus.

FIG. 12 is a longitudinal drawing of the same light warning apparatus.

FIG. 13 is a frontal drawing showing the lens used in the same light warning apparatus.

FIG. 14 is a planar drawing showing the same lens.

FIG. 15 is a back view showing the same lens.

FIG. 16 is a planar drawing showing the reflecting mirror used in the same light warning apparatus.

FIG. 17 is a longitudinal drawing showing the reflecting mirror used in the same light warning apparatus.

FIG. 18 is a frontal drawing showing the reflecting mirror used in the same light warning apparatus.

FIG. 19 is a perspective view of an exemplary wall-mounted signaling device in accordance with the present invention.

FIGS. 20A-20C are various views of a mirror and lens cover used in the exemplary signaling device.

FIG. 21 is a block diagram illustrating the interconnection of functional elements of the exemplary signaling device.

FIG. 22 is a schematic drawing of an embodiment of a variable power control circuit for use in the exemplary signaling device.

FIGS. 23A-23C are various views of an alternative embodiment of a lens cover for use in the exemplary signaling device.

FIGS. 24A-24B are frontal views of the red colored-coded reflecting mirror adjacent to its corresponding red tinted lens cover.

FIGS. 25A-25B are frontal views of the green colored-coded reflecting mirror adjacent to its corresponding green tinted lens cover.

FIGS. 26A-26B are frontal views of the amber colored-coded reflecting mirror adjacent to its corresponding amber tinted lens cover.

FIGS. 27A-27B are frontal views of the blue colored-coded reflecting mirror adjacent to its corresponding blue tinted lens cover.

### DETAILED DESCRIPTION OF THE INVENTION

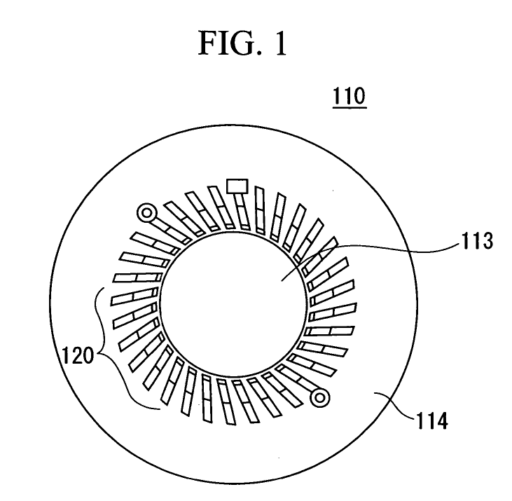

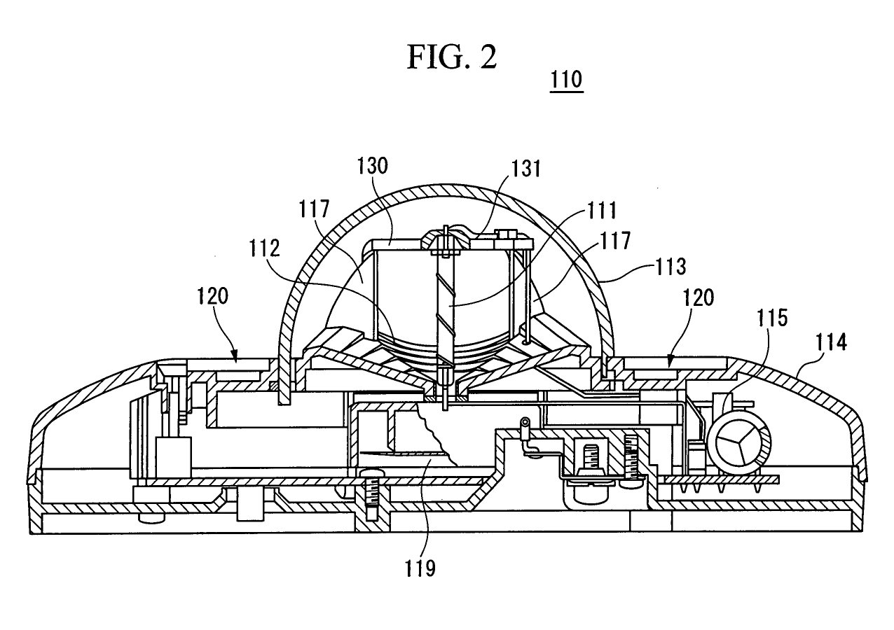

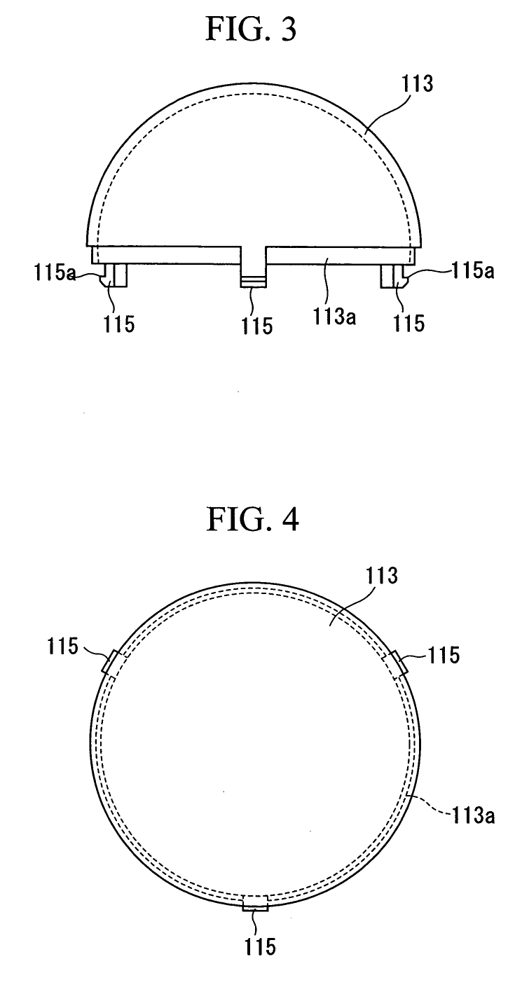

Below, the embodiments of the present invention will be explained with reference to the figures. FIG. 1 is a planar drawing showing an embodiment of the light warning apparatus of the present invention; FIG. 2 is an enlarged longitudinal drawing showing the same light warning apparatus; FIG. 3 is a frontal drawing showing the lens used in the same light warning apparatus; and FIG. 4 is a planar drawing showing the same lens. Here, the light warning apparatus 110 provides a strobe light source 111, a reflecting mirror 112 that reflects the light from this strobe light source, a lens 113 that covers the strobe light source 111 and the reflecting mirror 112, and an apparatus body 114 by which these elements are supported.

The strobe light source 111 generates light by using a drive circuit 115 provided in the apparatus body 114 or an externally provided drive circuit (not illustrated).

The lens 113 has the semispherical shape as shown in FIG. 3 and FIG. 4, and is formed by a translucent member such as a polycarbonate. In addition, the lens 113 can be arbitrarily tinted blue, red, green, amber, or the like. Furthermore, an installation step 113a is formed on the bottom end of the lens 113, and engagement catches 115 are formed at 120-degree intervals with respect to the center. In addition, an engagement step 115a is formed facing outward on an engagement catch 115. Therefore, the lens 113 can be snapped onto the apparatus body 114.

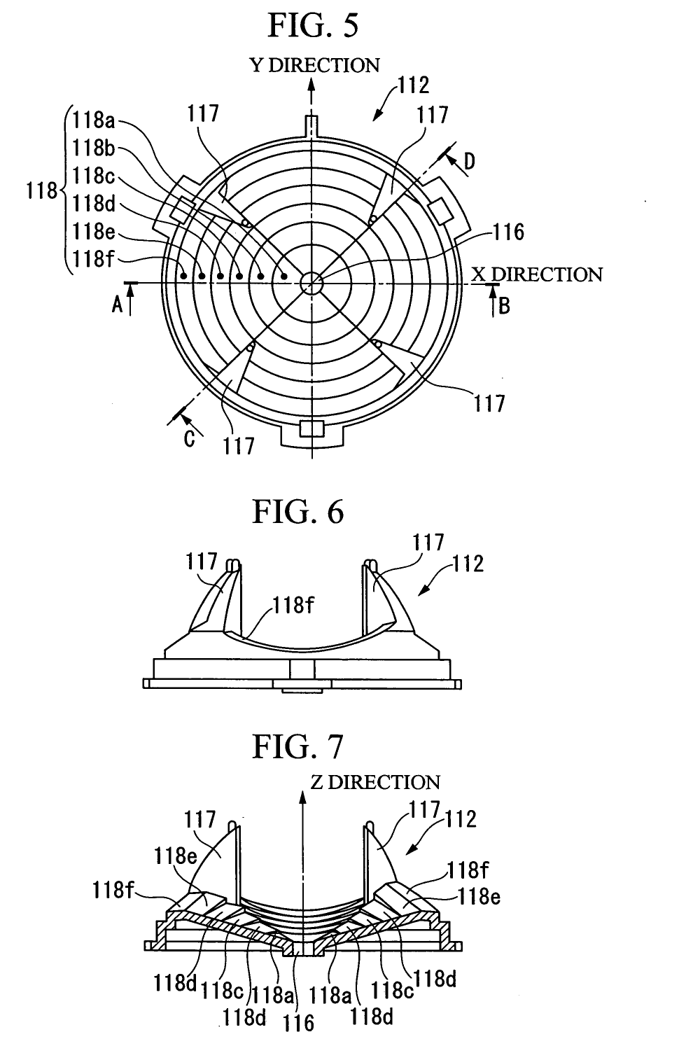

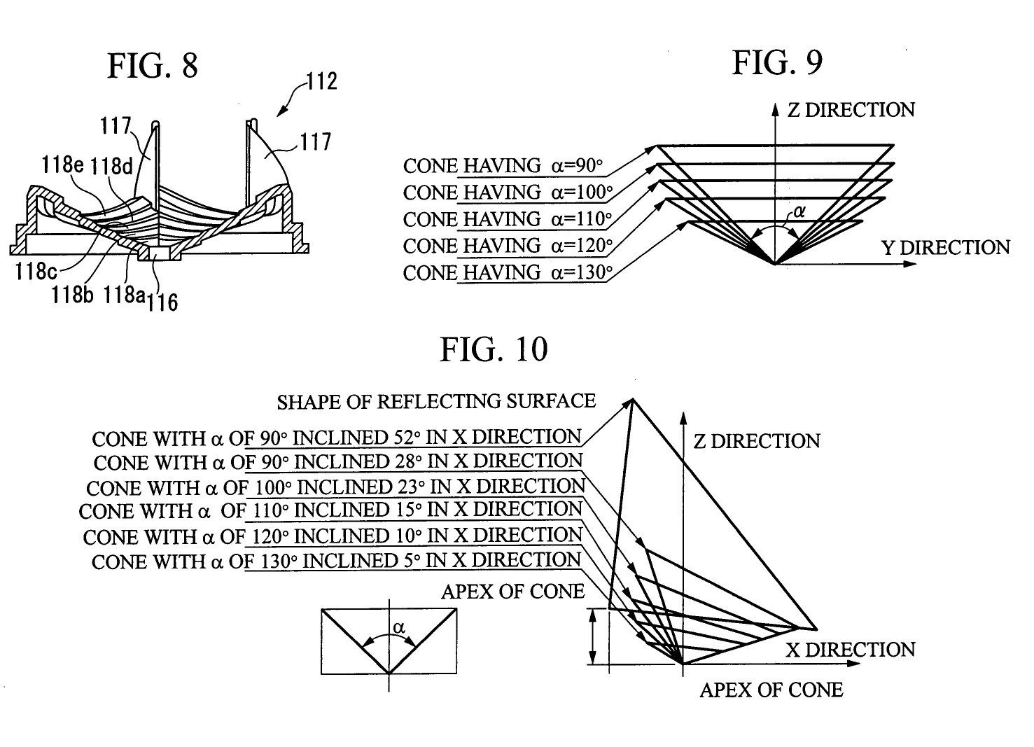

In the present embodiment, the reflecting mirror 112 is disposed at the approximate center of the apparatus body 114, and will be explained in detail with reference to FIG. 5 to FIG. 10. FIG. 5 is a planar drawing showing the reflecting mirror used in the light warning apparatus of the present invention; FIG. 6 is a frontal drawing of the same; FIG. 7 is a cross-sectional drawing of the reflecting mirror shown in FIG. 5 along the line A-B; and FIG. 8 is a cross-sectional drawing of the reflecting mirror shown in FIG. 5 along the line C-D. The reflecting mirror 112 has an installation hole 116 at the center in which the strobe light source is installed, and four supporting columns 117 for supporting the distal end of the strobe light source 111 disposed projecting upward. In addition, the reflecting mirror 112 is formed by a plurality of reflecting surfaces 118 disposed concentrically. Each of the reflecting surfaces 118a to 118f has a respectively differing slope. As is explained by FIG. 5, FIG. 9, and FIG. 10, the reflecting surface 118a has the shape of a cone with an apex angle of 130° inclined 5° in the X direction. In addition, the reflecting surface 118b has the shape of a cone with an apex angle of 120° inclined 10° in the X direction. In addition, the reflecting surface 118c has the shape of a cone with an apex angle of 110° inclined 15° in the X direction. In addition, the reflecting surface 118d has the shape of a cone with an apex angle of 100° inclined 23° in the X direction. In addition, the reflecting surface 118e has the shape of a cone with an apex angle of 90° inclined 28° in the X direction. In addition, the reflecting surface 118f has the shape of a cone with an apex angle of 90° inclined 52° in the X direction. As shown in FIG. 5, reflecting surfaces 118a to 118f formed in this manner constitute a concave surface shape, and are disposed in four sections.

After a surface finishing processing of the reflecting surfaces 118, aluminum vapor deposition is carried out. In addition, the following coating is carried out on the aluminum vapor deposition surface. First, an undercoat layer of approximately 15 μm is applied, then an aluminum vaporization layer of approximately 1500 Å is deposited, and finally a topcoat layer of approximately 13 μm is applied. In addition, the topcoat layer protects the aluminum vaporization surface, and is tinted blue, red, green, amber, or the like to match the tint of the lens 113 described above. Therefore, the aluminum vaporization surface is formed by a vaporization film comprising one type of metal, and it is possible to obtain strobe light having various colors with a minimum of specification changes by providing the necessary color to only the topcoat layer. In addition, in the case that the color of the topcoat layer differs from the color of the lens 113, it is possible to obtain various colors by a combination of these colors.

A support rod 130 is suspended across the distal ends of the supporting columns 117, and as shown in FIG. 2, the distal end of the strobe light source 111 is supported and supplied with electricity by the wiring 131.

In addition, as shown in FIG. 1 and FIG. 2, in proximity to the lens 113, a plurality of small holes 120 are provided for emitting a warning sound from the warning sound generating mechanism 119. Thus, in addition to light, the light warning apparatus 110 can emit a warning using sound.

The light warning apparatus 110 having the structure described above can be disposed outdoors, on the surface of a wall of a building, or on a ceiling, and can issue a warning in the vicinity using light or sound. In addition, because the reflecting surfaces 118 of the reflecting mirror 112 are tinted and the lens 113 is tinted with the same color, the white strobe light source 111 can have imparted any arbitrary color, and thereby the effectiveness of the warning is improved. Furthermore, because the reflecting mirror 112 is formed by combining a plurality of reflecting surfaces 118, the light from the light source is effectively scattered, and the effectiveness of the warning is further increased.

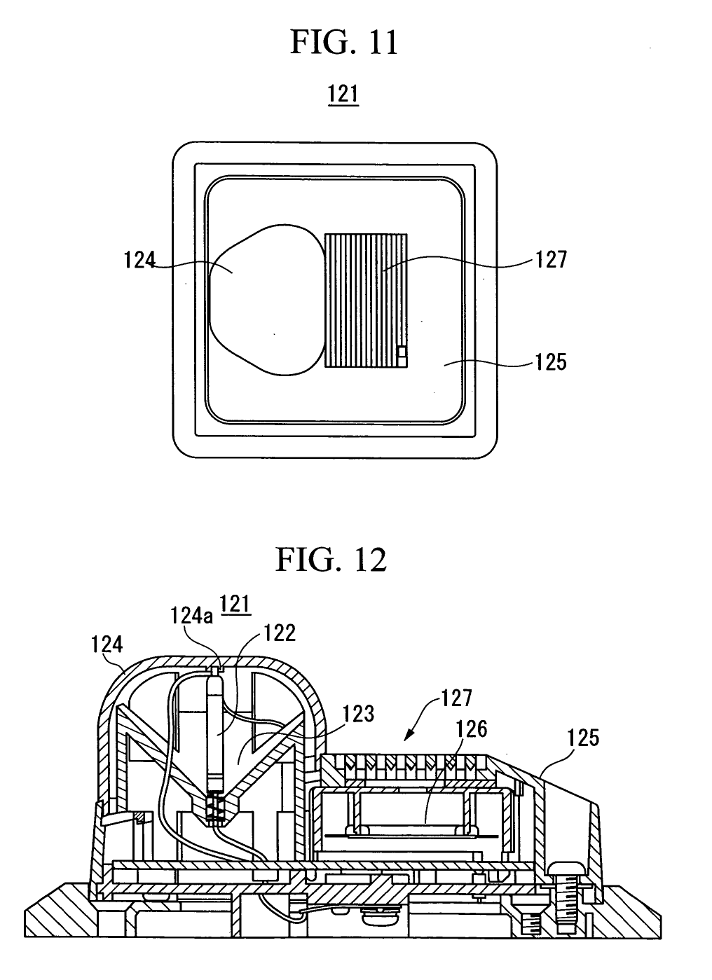

FIG. 11 to FIG. 18 show another embodiment of the present invention. FIG. 11 is a planar drawing showing this other embodiment of the light warning apparatus of the present invention, and FIG. 12 is a longitudinal drawing of the light warning apparatus of the present invention. Here, the light warning apparatus 121 provides a strobe light source 122, a reflecting mirror 123 that reflects the light from the strobe light source, a lens 124 that covers the strobe light source 121 and the reflecting mirror 123, and an apparatus body 125 that supports these elements. In addition, next to the lens 124, a plurality of openings 127 is provided for emitting the warning sound from the warning sound generating mechanism disposed in the apparatus body 125.

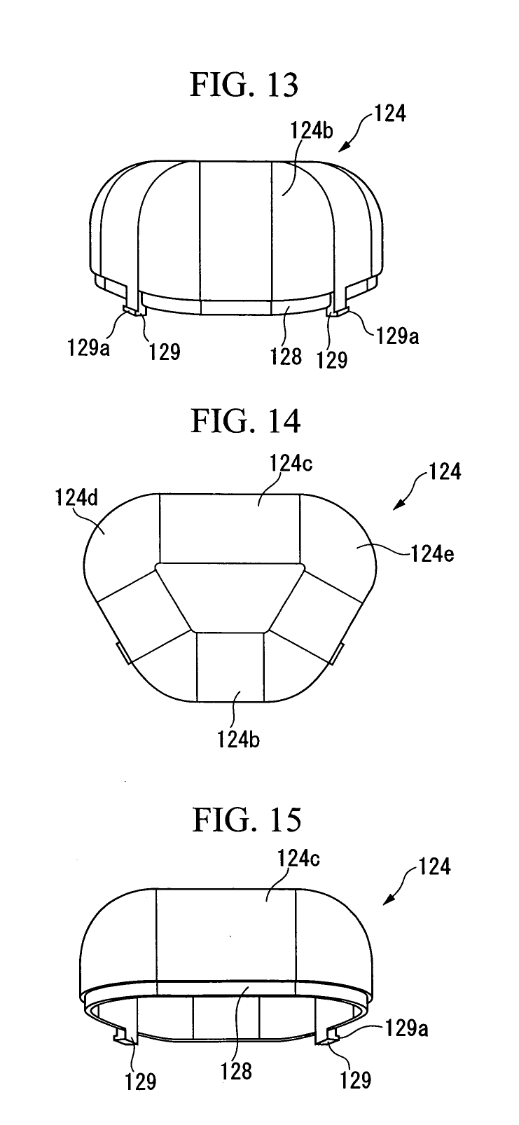

FIG. 13 is a frontal drawing showing the lens 124 used in the light warning apparatus 121; FIG. 14 is a planar drawing of the lens 124; and FIG. 15 is a back view of the lens 124. The lens 124 is formed from a transparent material such as polycarbonate, and is tinted blue, red, green, amber, or the like. The lens 124 has an engagement concavity 124a that supports the distal end of the strobe light source 122 on the inner wall or ceiling, and is formed from a plurality of curves. The curved surfaces 124b and 124c undergo mirror finish processing. In addition, the bottom end of the lens 124 has an installation step 128 and an engagement catch 129. The engagement catch 129 has an engagement step 129a that faces outwards. Therefore, when installing the apparatus body 125, it can be snapped on.

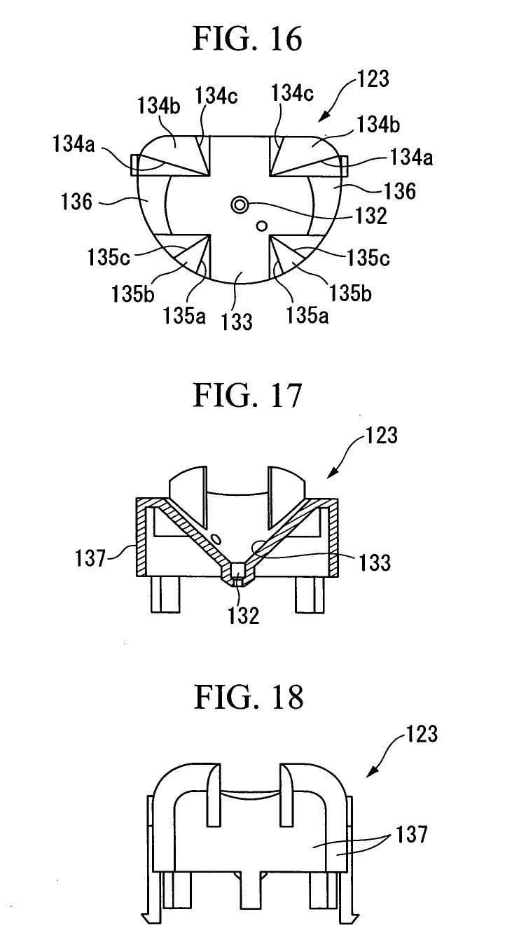

FIG. 16 is a planar drawing showing the reflecting mirror 123 used in the light warning apparatus 116; FIG. 17 is a longitudinal drawing of the reflecting mirror 123; and FIG. 18 is a frontal drawing of the reflecting mirror 123. The reflecting mirror 123 consists of the conical reflecting surface 133 having an installation hole 132 for installing the strobe light source 122 in the center, and reflecting surfaces 134a, 134b, and 134c, reflecting surfaces 135a, 135b, and 135c, and reflecting surface 136, which have slopes that differ from that of reflecting surface 133. In addition, the reflecting surfaces 133, 134, 135, 136, and 137 undergo a mirror finish processing, and aluminum vaporization is implemented. Like the previous embodiment, the following coating is carried out. First, on the aluminum vapor deposition surface an undercoat layer of approximately 15 μm is applied, then an aluminum vaporization layer of approximately 1500 Å is deposited, and finally a topcoat layer of approximately 13 μm is applied. In addition, the topcoat layer protects the aluminum vaporization surface, and is tinted blue, red, green, amber, or the like to match the coloring of the lens 113 described above.

In addition, as shown in FIGS. 11 and 12, next to the lens 124, an opening 127 is formed, and it is possible to sound the warning sound generated by the warning sound generating mechanism.

The light warning apparatus 121 structured as described above can generated a warning in its vicinity using sound or light.

The present invention satisfies the need for a color-coded visual signaling system that can be adapted for various emergency situations that may be defined by industrial applications and/or government regulations. In the detailed description that follows, like element numerals are used to describe like elements illustrated in one or more of the figures.

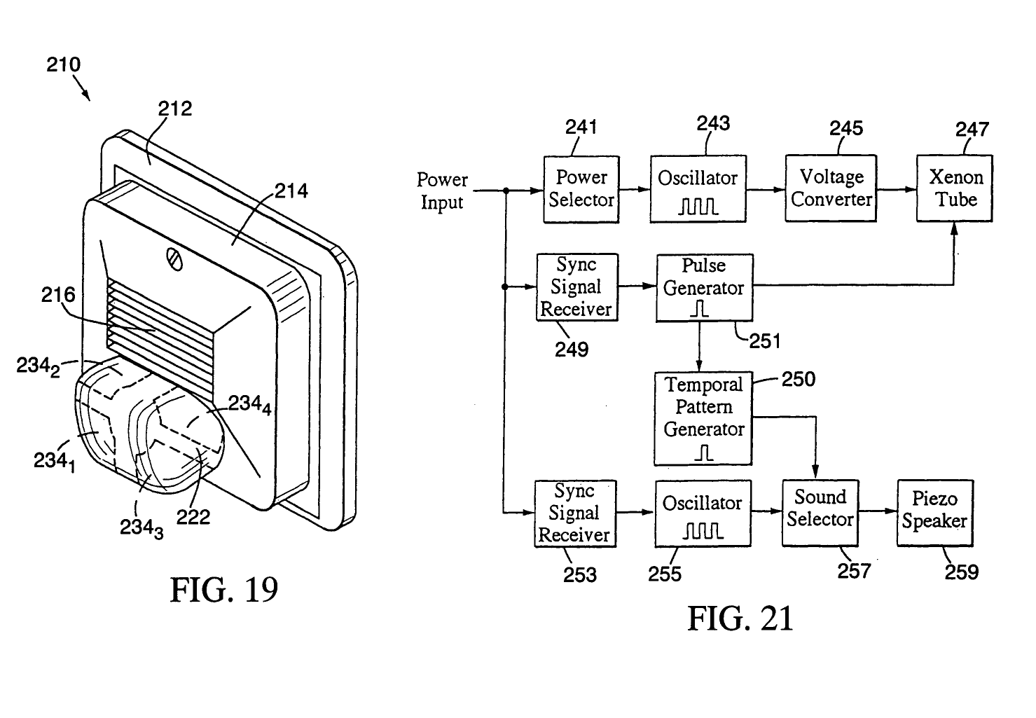

Referring first to FIG. 19, a perspective view of an exemplary visual color-coded emergency signaling device 210 is illustrated. It is anticipated that the signaling device 210 be mounted to an interior wall of a building or other public facility, though it should be appreciated that the present invention is equally applicable to ceiling-mounted signaling devices. The wall would typically include an outlet box (not shown) that facilitates electrical and mechanical connection to the signaling device 210. The signaling device 210 includes a mounting plate 212 and a housing 214. The mounting plate 212 provides a decorative frame that comes into contact with the wall and surrounds the housing 214. The mounting plate 212 additionally masks any unsightly edges of the outlet box that may be visible. The housing 214 protrudes outwardly from the mounting plate 212, and contains the electrical circuitry of the signaling device 210. A grille 216 is provided in the forward-facing surface of the housing 214. A sound generating device, such as a speaker, may be disposed within the housing 214 adjacent to the grille 216. The grille 216 includes louvers that permit movement of air from the speaker within the lens cover while precluding condensation from entering the housing 214. The housing 214 may be comprised of a lightweight material, such as thermoplastic or sheet metal.

The signaling device 210 further includes a tinted lens cover 222 which covers a portion of the forward-facing surface of the housing 214 adjacent to the grille 216. The tinted lens cover 222 provides a cover for a reflecting mirror (described below) used to reflect the signaling strobe light, and may also serve as a lens to direct the distribution of the transmitted light. The tinted lens cover 222 serves to protect the relatively delicate reflecting mirror and light emitter from inadvertent harm. The tinted lens cover 222 may be comprised of tinted plastic or glass to permit the signaling light to pass therethrough without distortion, and has a generally rounded or oval shape. It should be appreciated that other shapes and configurations of the signaling device 210, and particularly the tinted lens cover 222, may be utilized in accordance with the present invention.

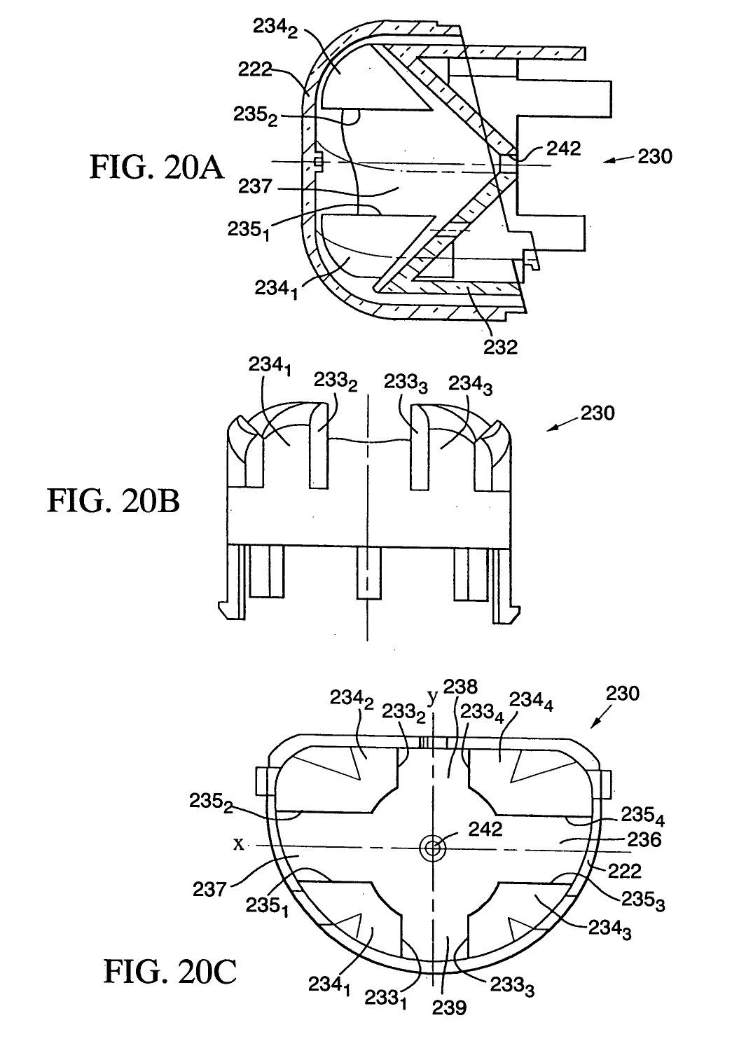

Referring now to FIGS. 20A-20C, the tinted lens cover 222 and an exemplary configuration of the reflecting mirror 230 for an emergency signaling device are illustrated in greater detail. The reflecting mirror 230 may include four corner reflectors 234₁-234₄ disposed at respective quadrants of the mirror 230, as shown in FIG. 20C. The corner reflectors 234₁-234₄ are separated in a first axial dimension (hereinafter referred to as the x-axis) by channel segments 236, 237, and are separated in a second axial dimension (hereinafter referred to as the y-axis) by channel segments 238, 239. The first axial dimension and channel segments 236, 237 are disposed perpendicularly with reference to the second axial dimension and channel segments 238, 239. The corner reflectors 234₁-234₄ further include first side walls 235₁-235₄ that define the edges of the x-axis channel segments 236, 237 and second side walls 233₁-233₄ that define the edges of the y-axis channel segments 238, 239. The x-axis channel segments 236, 237 are disposed on an angle with respect to each other such that the channel segments are closest to the tinted lens cover 222 at outermost edges thereof, as shown in cross section in FIG. 20A. Similarly, the y-axis channel segments 238, 239 are disposed on an angle with respect to each other such that the channel segments are closest to the tinted lens cover 222 at outermost edges thereof. At the center of the intersection formed between the x-axis channel segments 236, 237 and the y-axis segments 238, 239 is a hole 242 through which a light emitter is disposed, such as a xenon tube. The hole 242 is disposed at the most distant point of the reflecting mirror 230 from the tinted lens cover 222.

The various surfaces of the reflecting mirror 230, and particularly the x and y-axis channel segments 236, 237, 238, 239, are tinted with a colored reflective material, such as a colored metallic reflective coating. It should be appreciated that the x-axis channel segments 236, 237 serve to reflect light in a first generally planar region having a field of view defined by the angle between the x-axis channel segments. Similarly, the y-axis channel segments 238, 239 serve to reflect light in a second generally planar region having a field of view defined by the angle between the y-axis channel segments. In a preferred embodiment of the colored reflecting mirror 230, the angle between each of the x-axis channel segments 236, 237 and the y-axis channel segments 238, 239 is Ninety degrees. The orientation of the x and y-axis channel segments 236, 237, 238, 239 is intended to provide a polar light distribution to enable a person to see the light from a wide range of viewing angles. The four corner reflectors 234₁-234₄ serve to further direct light from the light emitter onto the x and y-axis channel segments 236, 237, 238, 239 to concentrate the light in a polar light distribution.

Referring now to FIG. 21, a block diagram showing the functional elements of an emergency signaling device 210 is provided. The signaling device receives a DC power input signal (such as 24 volts DC) onto which one or more synchronization signals may be superimposed. A first type of synchronization signal enables a flashing rate of the light to be synchronized with that of other signaling devices that may be operating simultaneously within the same field of view. Similarly, the second type of synchronization signal enables the audible tone generated by the signaling device to be synchronized with that of other signaling devices within the same range of hearing. The use of these synchronization signals is well known in the art.

The signaling device includes a power selector 241, an oscillator 243, a voltage converter 245 and a xenon tube 247. The xenon tube 247 is the light emitter, and the power selector 241, oscillator 243, and voltage converter 245 provide a DC-to-DC converter used to provide driving current for the xenon tube 247. More particularly, the DC power input signal is provided to the power selector 241 which determines the intensity level of the emitted light. The power selector 241 may include a switch or potentiometer that allows a user to select between defined power levels. It should be appreciated that the power level applied to the xenon tube 247 light emitter corresponds to the intensity level of the emitted light. The oscillator 243 provides an oscillating or AC signal the frequency of which depends on the power level selected by the power selector 241. The voltage converter 245 converts the AC signal generated by the oscillator 243 back into a DC voltage used to drive the xenon tube 247 (such as around 270 volts DC). A sync signal receiver 249 demodulates the synchronization signal that is superimposed on the power input signal. The sync signal drives a pulse generator 251 to provide a series of triggering pulses at a timing defined by the synchronization signal. The triggering pulses from the pulse generator 251 are provided to the xenon tube 247, which trigger the xenon tube to flash once for each such triggering pulse.

A second sync signal receiver 253 demodulates a second synchronization signal superimposed on the power input signal for synchronizing the audible tones generated by the signaling device. As known in the art, the audible tones generated by a signaling device can be provided in several patterns. The simplest pattern comprises a continuous periodic signal with pulses of a fixed on-duration separated by periods of a fixed off-duration. A more complex pattern is defined by ISO 9000, referred to as a temporal sound pattern, comprises a short series of pulses (such as three pulses) having a fixed on-duration separated by periods of a fixed off-duration, with successive ones of the series separated by a longer off-duration. Other types of patterns may also be generated, such as a warble tone or a continuous sound. The second synchronization signal recovered by the sync signal receiver 253 is used to drive an oscillator 255 that generates a continuous series of pulses. A temporal pattern generator 250 determines the pattern of audible tones to be provided by the signaling device. As discussed above, the pulse generator 251 that triggers the xenon tube 247 may also be used to trigger the temporal pattern generator 250, so that the longer off-duration which separates the short series of pulses is synchronized to the flashing of the strobe light. The temporal pattern generator 250 and the oscillator 255 provide signals to a sound selector 257 that generates audio tone signals. The audio tone signals are provided to a piezoelectric speaker 259, which converts the tone signals into audible tones. It should be appreciated that the signaling device may not necessarily include an audible tone generator, and that separate signaling devices may be used for visual and audible signaling.

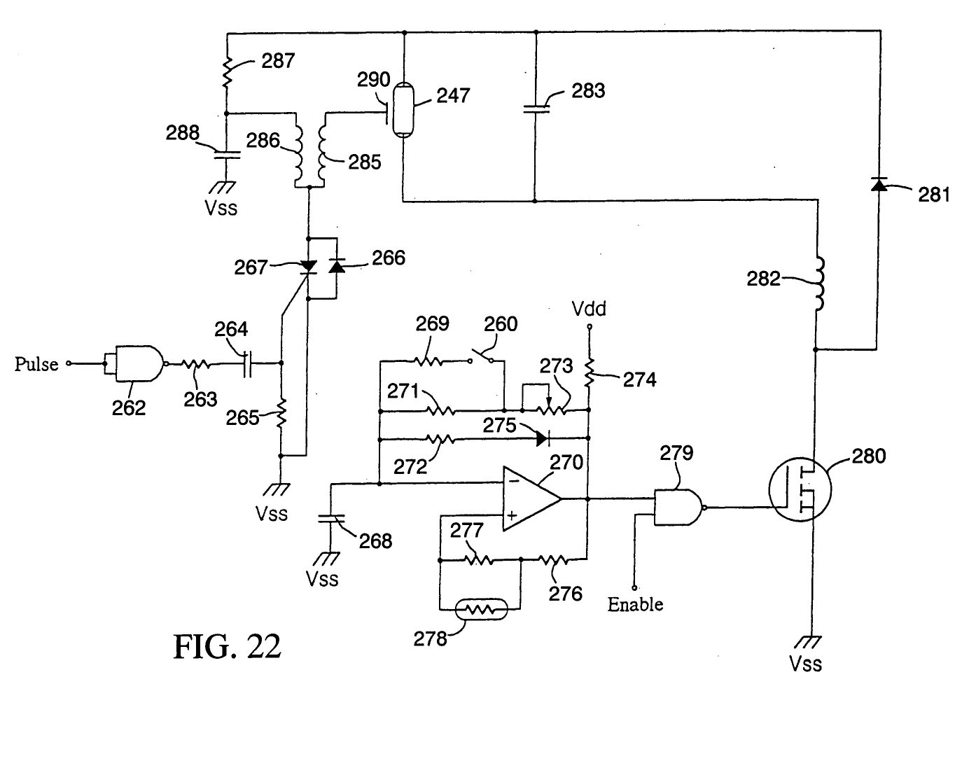

An embodiment of the signal driving portions of the emergency signaling device is shown in greater detail in FIG. 22. An oscillator circuit is provided by an operational amplifier 270 that has an inverting input terminal coupled to ground (Vss) through a capacitor 268. A DC voltage source (vdd) is coupled to the output terminal of the operational amplifier across a resistor 274. Resistors 271, 272 and 273 define a feedback resistance coupled between the output terminal of the operational amplifier 270 and the inverting input terminal. The resistor 272 is disposed in parallel with the resistors 271 and 273 which are coupled in series. The resistor 273 is a variable resistor which permits the feedback resistance value to be calibrated to a desired level. A diode 275 is provided in series with the resistor 277 to prevent current from conducting in the forward direction through the feedback resistance.

An additional resistor 269 is provided in series with a switch 260. With the switch 260 in the closed position, the resistor 269 is coupled in parallel with the resistor 271, which alters the feedback resistance value. Conversely, with the switch 260 in the open position, the resistor 269 has no effect on the feedback resistance value. As known in the art, the frequency of an oscillating signal provided at the output of the operational amplifier 270 is proportional to the inverse of the product of the feedback resistance and the capacitance at the inverting input terminal (1/RC). Thus, the switch 260 enables the oscillator circuit to operate at two different frequencies. As will be further described below, the two different frequencies cause the xenon tube to be driven at different current levels, providing two intensity levels of operation of the signaling device. It is anticipated that the switch 260 be provided on an external surface of the housing 214, so that an operator or installer of the signaling device may select a desired intensity level.

The oscillating signal from the operational amplifier 270 is provided to an input terminal of a NAND gate 279. A second input terminal of the NAND gate 279 is coupled to an enabling signal. When the enabling signal is applied to the NAND gate 279, the oscillating signal passes therethrough. The oscillating signal is then provided to the gate of a transistor 280, such as a MOSFET. The transistor 280 is driven to conduction by positive-going cycles of the oscillating signal. A voltage converter circuit is provided by an inductor 282 and a capacitor 283 coupled in parallel. The inductor 282 is coupled to the drain of the transistor 280. When the transistor 280 is in a conducting state, an electrical current is drawn into the inductor 282. Then, when the transistor 280 is non-conductive, the current discharges into the capacitor 283, which achieves a particular voltage. The capacitor 283 is coupled in parallel across the xenon tube 247, such that the voltage across the capacitor is applied across the xenon tube 247. As known in the art, the voltage across the xenon tube 247 determines the brightness or intensity of its light output. The frequency of the oscillating signal provided from the operational amplifier 270 determines the amount of charging of the capacitor 283. Thus, by varying the frequency of the oscillating signal, the intensity of the xenon tube 247 can be varied.

The xenon tube 247 further includes an anode 290 that triggers flashing. A triggering pulse is provided to an inverter 262, a resistor and a capacitor 264. The capacitor 264 filters high frequency components of the triggering pulse, such as harmonics of the triggering pulse. The anode 290 is coupled to a transformer having mutual inductances 285, 286 that are coupled to ground through a pair of alternating diodes 266, 267. Between triggering pulses, a voltage is provided across resistor 265, which draws a current through diode 266 that is stored in inductors 286 and 285. The voltage defined across the inductor 285 causes the anode to stand off conduction within the xenon tube 247. When the triggering pulse is provided, however, the current reverses direction and discharges from the inductors 286, 285 through diode 267. The discharging of the inductor 285 causes the voltage to drop at the anode 290 and the xenon tube 247 conducts current, resulting in a momentary flash of light from the xenon tube. In a preferred embodiment of the invention the feedback resistance between the inverting input terminal and the output terminal of the operational amplifier 270 is selected to generate oscillating signals that result in selectable intensity levels of the xenon tube 247 between a low and a high level, as determined by the position of the switch 260.

A feedback resistance is also defined between the output terminal of the operational amplifier 270 and the non-inverting input terminal of the operational amplifier. This feedback resistance includes resisters 276, 277, and 278. Resister 278 further comprises a thermister, which has a resistance value that varies with the temperature of the device. This way, if the signaling device becomes excessively hot due to flashing of the xenon tube 247, the frequency of the oscillating signal provided by the operational amplifier 270 will decrease due to the increased feedback resistance at the non-inverting input terminal. The decreased frequency results in a reduced light intensity of the xenon tube 247, which serves to prevent the signaling device 210 from overheating.

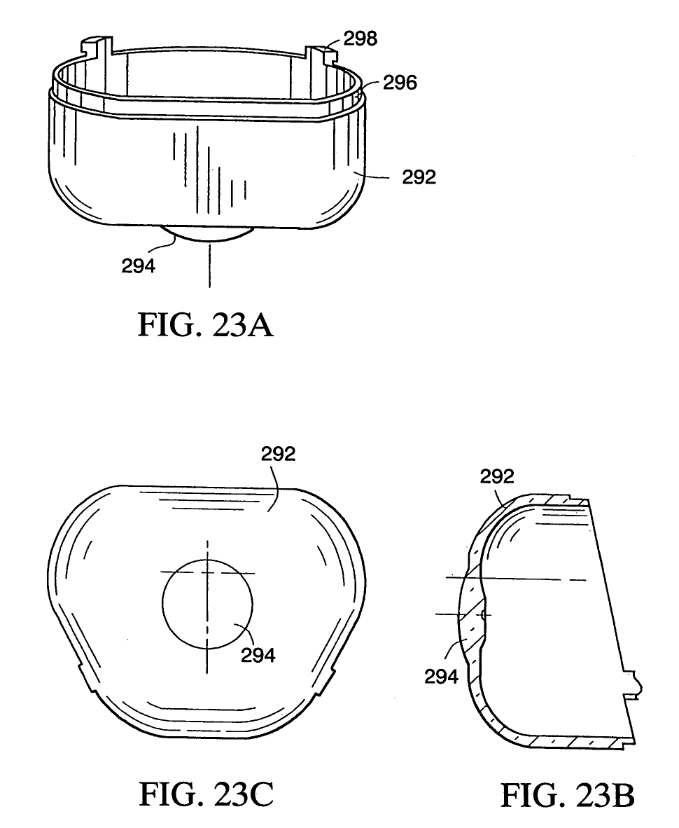

FIGS. 23A-23C illustrate an alternative embodiment of a tinted lens cover 292 used to cover the colored reflecting mirror 230. The tinted lens cover 292 includes a convex lens 294 disposed in a central portion of the lens cover, corresponding to the center of the intersection formed between the x-axis channel segments 236, 237 and the y-axis segments 238, 239 of FIGS. 20A-20C. As described above, the lens cover 292 may be comprised of materials such as glass or plastic. An outer edge region 296 permits the lens cover 292 to engage the forward-facing surface of the housing 214, and further includes hooks 298 that engage corresponding engagement members of the housing 214. The lens 294 cooperates with the reflecting mirror 230 to satisfy the polar light distribution requirements by dispersing and focusing the reflected light. The lens cover 292 may further include concave lens portions as will as prism regions disposed along the x-axis and y-axis dimensions.

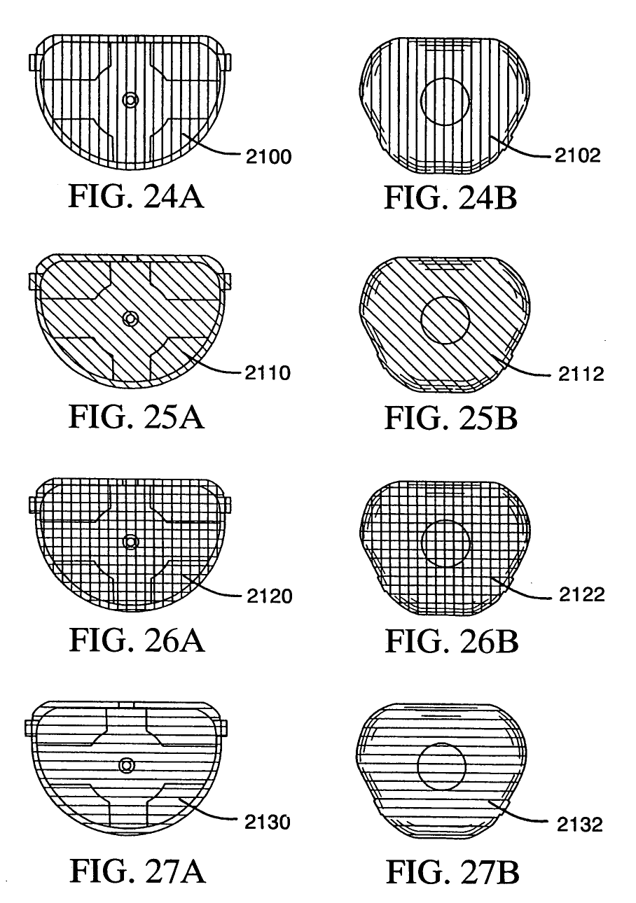

Referring now to FIGS. 24A-24B, 25A-25B, 26A-26B, and 27A-27B, a frontal view of the colored reflecting mirrors 2100, 2110, 2120, 2130 are shown adjacent to their corresponding tinted lens covers 2102, 2112, 2122, and 2132, respectively. Each assembly, comprising the colored reflecting mirror with its respective tinted lens cover, is colored a specific color red (colored reflecting mirror 2100 and tinted lens cover 2102), green (colored reflecting mirror 2110 and tinted lens cover 2112), amber (colored reflecting mirror 2120 and tinted lens cover 2122), and blue (colored reflecting mirror 2130 and tinted lens cover 2132). These colors are exemplary as they are likely to be used or are used to denote specific emergencies as defined by industry standards and/or government regulations. Other colors could be selected and incorporated into the present invention as appropriate.

The presently existing selectable strobe ceiling-mounted devices have white light outputs of 30 cd, 75 cd, and 110 cd for silver reflecting mirrors behind xenon tubes and clear lens covers. Using the same power input levels as used to generate these outputs for white lights, the candela output for the red light of the strobe of the present invention have been measured at 15 cd, 28 cd, and 39 cd, respectively. Similarly, the candela output for the green light of the green strobe have been measured at 36 cd, 66 cd, and 91 cd, while the candela output for the amber light of the amber strobe have been measured at 32 cd, 59 cd, and 81 cd, respectively. Finally, the candela output for the blue light of the blue strobe have been measured at 18 cd, 33 cd, and 145 cd, respectively.

Similarly, selectable strobe white light wall-mounted devices may have outputs of 75 cd, and 110 cd for silver reflecting mirrors with xenon tubes behind clear lens covers. Using the same power input levels, the candela output for the red color strobe have been measured at 38 and 74 cd, respectively. Similarly, the candela output for the green strobe have been measured at 90 cd and 173 cd, while the candela output for the amber strobe have been measured at 80 and 155 cd, respectively. Finally, the candela output for the blue strobe have been measured at 45 cd and 86 cd, respectively.

By contrast, measurements on prior colored signaling light systems that have darkly tinted lens covers in front of silver mirrors have much lower candela output intensities than the outputs of the lights of the present invention. In order to get the same intensity levels in previous colored signaling light systems to those of the present invention, the power supply to the xenon tube would need to be increased significantly. The present invention, however, allows brighter colored light to be viewed by the observer due to the lighter tinting of the lens cover when coupled to the colored reflecting mirror. The present invention can therefore achieve higher colored light intensity levels with a lower power output when compared to older colored signaling light systems, thereby conserving energy and intensifying the light for the observer.

One application of the applicant's invention may be the assignment of the different colors to denote specific emergencies. For example, an application may be a system which assigns a red colored light signal to denote a fire emergency, a green colored light signal to denote a chemical emergency, an amber colored light signal to denote an armed intruder threat, and a blue colored light signal to denote a tornado or hurricane emergency. An alternate application of the applicant's invention may be the use of the colorized reflector coupled to the tinted lens cover for brake lights, traffic light signals, or other types of warning light signals. Such embodiment would realize the same benefits as those of applicant's visual color-coded signaling system invention, such as increased colored light output without an increase in power supply and energy conservation.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A light warning apparatus comprising:
a strobe light source;
a reflecting mirror that reflects the light from said strobe light source; and
a lens that covers said strobe light source and said reflecting mirror,
wherein a tinted coating layer is formed on the surface of said reflecting mirror.

2. A light warning apparatus according to claim 1, wherein said lens and said tinted coating layer are tinted with the same color.

3. A light warning apparatus according to claim 1, wherein said reflecting mirror is formed by reflecting surfaces having a plurality of slopes.

4. A light warning apparatus according to claim 1, wherein said reflecting mirror has a concave shape formed by a plurality of conical surfaces whose apex angles differ.

5. A light warning apparatus according to claim 1, wherein a warning sound generating mechanism is provided in proximity to said lens.

6. A colored light signaling device, comprising:
a tinted lens cover;
a colored reflecting mirror coupled behind said tinted lens cover; and
a light emitting device disposed in front of said colored reflecting mirror and covered by said tinted lens cover.

7. The signaling device of claim 6, wherein said light emitting device further comprises a xenon tube.

8. The signaling device of claim 6, wherein said colored reflecting mirror further comprises four corner reflectors separated by channel segments disposed in first and second axial directions.

9. The signaling device of claim 6, wherein said colored reflecting mirror is coated with a colored reflective coating and is coupled to a tinted lens cover of a corresponding color.

10. The signaling device of claim 6, wherein said light emitting device is a strobe light.

11. The signaling device of claim 8, wherein respective ones of said channel segments disposed in said first axial direction are further disposed in an angle with respect to each other to provide a predetermined light distribution pattern.

12. The signaling device of claim 11, wherein respective ones of said channel segments disposed in said second axial direction are further disposed in an angle with respect to each other to provide said predetermined light distribution pattern.

13. The signaling device of claim 11, wherein said predetermined light distribution pattern comprises a polar light distribution pattern.

14. The signaling device of claim 10, further comprising means for synchronizing said strobe light to flash in a synchronized pattern with at least one other signaling device.

15. The signaling device of claim 6, wherein said colored reflecting mirror is colored with a tinted metallic coating, the tint color selected from the group consisting of amber, red, green and blue.

16. The signaling device of claim 15, wherein the candela intensity of said colored light output is at least fifty percent of the candela intensity of a non-colored lens cover and silver reflecting mirror for identical input power levels.

17. The signaling device of claim 15, wherein the candela intensity of said colored light output is at least equal to the candela intensity of a non-colored lens cover and silver reflecting mirror for identical input power levels.

18. The signaling device of claim 15, wherein said signaling device has a housing to allow said signaling device to be mounted to an interior surface of a building.

19. A visual signaling device comprising:
a flashing strobe light;
a color-coated reflecting mirror; and
a colored lens cover having a color matched to the color of the color-coated reflecting mirror.
